(19) United States
(12) Patent Application Publication
(10) Pub. No.: US 2011/0204782 A1
(43) Pub. Date: Aug. 25, 2011

(54) Plasma Lamp with Dielectric Waveguide Body Having a Width Greater Than a Length

(75) Inventors: Frederick M. Espiau, Topanga, CA (US); Mehran Matloubian, Encino, CA (US)

(73) Assignee: Topanga Technologies, Inc., Topanga, CA (US)

(21) Appl. No.: 12/814,229

(22) Filed: Jun. 11, 2010

Related U.S. Application Data
(60) Provisional application No. 61/186,812, filed on Jun. 12, 2009.

(51) Int. Cl. H01J 7/46

(52) U.S. Cl. 315/39

(57) ABSTRACT

A plasma lamp includes a waveguide body which has at least one solid dielectric material. The body has a diameter and a length transverse to the diameter, with the diameter of the body being less than the length of the body. The lamp also has a power source configured to provide power to the body at a resonant frequency. The waveguide body has an effective length of at least portions of the diameter and the length.

### CROSS-REFERENCE TO RELATED APPLICATION

The present invention claims priority to U.S. Provisional Patent Application No. 61/186,812, filed Jun. 12, 2009, which is hereby incorporated by reference for all purposes.

### BACKGROUND OF THE INVENTION

The present invention relates generally to lighting techniques. In particular, the invention provides a method and device using an electrodeless plasma lighting device having a dielectric waveguide body having a width greater than a length, although it may be provided in other spatial configurations. The invention can be applied to a variety of applications such as stadiums, security, parking lots, military and defense, streets, large and small buildings, vehicle headlamps, aircraft landing, bridges, warehouses, uv water treatment, agriculture, architectural lighting, stage lighting, medical illumination, microscopes, projectors and displays, and similar uses.

From the early days, human beings have used a variety of techniques for lighting. Early humans relied on fire to light caves during hours of darkness. Fire often consumed wood for fuel. Wood fuel was soon replaced by candles, which were derived from oils and fats. Candles were then replaced, at least in part by lamps. Certain lamps were fueled by oil or other sources of energy. Gas lamps were popular and still remain important for outdoor activities such as camping. In the late 1800, Thomas Edison, who is one of the greatest inventors of all time, conceived the incandescent lamp, which uses a tungsten filament within a bulb, coupled to a pair of electrodes. Many conventional buildings and homes still use the incandescent lamp, commonly called the Edison bulb. Although highly successful, the Edison bulb consumed much energy and was generally inefficient.

Fluorescent lighting replaced incandescent lamps for certain applications. Fluorescent lamps generally consist of a tube containing a gaseous material, which is coupled to a pair of electrodes. The electrodes are coupled to an electronic ballast, which helps ignite the discharge from the fluorescent lighting. Conventional building structures often use fluorescent lighting, rather than the incandescent counterpart. Fluorescent lighting is much more efficient than incandescent lighting, but often has a higher initial cost.

Shuji Nakamura pioneered the efficient blue light emitting diode, which is a solid state lamp. The blue light emitting diode forms a basis for the white solid state light, which is often a blue light emitting diode within a bulb coated with a yellow phosphor material. Blue light excites the phosphor material to emit white lighting. The blue light emitting diode has revolutionized the lighting industry to replace traditional lighting for homes, buildings, and other structures.

Another form of lighting is commonly called the electrodeless lamp, which can be used to discharge light for high intensity applications. Frederick M. Espiau was one of the pioneers that developed an improved electrodeless lamp. Such electrodeless lamp relied upon a solid ceramic resonator structure, which was coupled to a fill enclosed in a bulb. The bulb was coupled to the resonator structure via RF feeds, which transferred power to the fill to cause it to discharge high intensity lighting. The solid ceramic resonator structure has been limited to a dielectric constant of greater 2. An example of such a solid ceramic waveguide is described in U.S. Pat. No. 7,362,056, which is hereby incorporated by reference herein. Although somewhat successful, the electrode-less lamp still had many limitations. As an example, electrode-less lamps have not been successfully deployed in high volume for general lighting applications. Additionally, the conventional lamp also uses a high frequency and has a relatively large size, which is often cumbersome and difficult to manufacture and use. These and other limitations of the conventional lamp are described throughout the present specification and more particularly below.

From the above, it is seen that improved techniques for lighting are highly desired.

### BRIEF SUMMARY OF THE INVENTION

This present invention provides a method and device using an electrodeless plasma lighting device having a dielectric waveguide body preferably having a width greater than a length. configurations. The invention can be applied to a variety of applications such as stadiums, security, parking lots, military and defense, streets, large and small buildings, vehicle headlamps, aircraft landing, bridges, warehouses, uv water treatment, agriculture, architectural lighting, stage lighting, medical illumination, microscopes, projectors and displays, as well as other uses.

An electrodeless plasma lamp includes a waveguide body, which has at least one solid dielectric material. The body has a diameter and a length transverse to the diameter. In a specific embodiment, the diameter of the body is less than the length of the body. The lamp also has an RF power source configured to provide power to the body at about a frequency that resonates within the body. The waveguide body has an effective length comprising at least a portion of the diameter and one or more portions of the length to cause the frequency to resonate within the body. The lamp also has a fill positioned proximate to the body to receive the power from the body, the fill of the plasma lamp capable of forming a plasma when the power is received from the body.

The invention provides a method and device having configurations of input, output, and feedback coupling elements that provide for electromagnetic coupling to the bulb whose power transfer and frequency resonance characteristics that are largely dependent upon a waveguide body having at least two materials. In a preferred embodiment, the present invention provides a method and configurations with an arrangement that provides for improved manufacturability as well as design flexibility. Other embodiments may include integrated assemblies of the output coupling element and bulb that function in a complementary manner with the present coupling element configurations and related methods for street lighting applications. In a preferred embodiment, the waveguide body comprises a dielectric material having a constant of 2 and less, which decreases capacitance of the resonator. For example, the dielectric material consists essentially of air (e.g., with a dielectric constant of about 1). In contrast, various types of conventional electrodeless lamps utilize high dielectric constant material in the waveguide to reduce the size of the waveguide. In certain embodiments of the present invention, dielectric materials such as air or fluid are used. For example, a portion or the entirety of a waveguide is filled with air. It is to be appreciated that air filled portion of the waveguide, compared to waveguide filled by high-dielectric constant material, has a reduced amount of RF loss (up to about 1 decibel) compared to conventional waveguide with high dielectric constant material, thereby improving performance. In addition, by filling a portion or an entirety of the waveguide with air instead of material with high dielectric constant, the manufacturing costs and weight of the waveguide are reduced. There are other benefits as well. In a specific embodiment, the diameter of the waveguide body is less than the width, which can lead to a greater effective length of the resonating body, but has the smaller diameter that is more compact and easier to fit-up into one or more form factors. The greater effective length of the resonating body leads to lower resonating frequencies according to one or more embodiments. In a specific embodiment, the present method and resulting structure are relatively simple and cost effective to manufacture for commercial applications. Depending upon the embodiment, one or more of these benefits may be achieved. These and other benefits may be described throughout the present specification and more particularly below.

The present invention achieves these benefits and others in the context of known process technology. However, a further understanding of the nature and advantages of the present invention may be realized by reference to the latter portions of the specification and attached drawings.

### BRIEF DESCRIPTION OF THE DRAWINGS

A more complete understanding of the present invention and its advantages will be gained from a consideration of the following description of preferred embodiments, read in conjunction with the accompanying drawings provided herein. In the figures and description, numerals indicate various features of the invention, and like numerals referring to like features throughout both the drawings and the description.

FIG. 1 is a simplified drawing of an embodiment of the present invention of an electrodeless plasma lamp with both an RF coupling element and a feedback coupling element.

FIG. 2A is a simplified drawing of an embodiment of the present invention of an electrodeless plasma lamp with an RF coupling element and without a feedback coupling element.

FIG. 2B is a simplified perspective view of the lamp in FIG. 2A illustrating the electrodeless plasma lamp with RF coupling element and without a feedback coupling element.

FIG. 3 is a simplified drawing of an embodiment of the present invention of an electrodeless plasma lamp. A folded resonator/waveguide structure is used to achieve a more compact structure.

FIG. 4 is a simplified drawing of another embodiment of the present invention of an electrodeless plasma lamp. It is similar to FIG. 3 but the resonator/waveguide consists of multiple dielectric materials as well as possibly air to improve the performance of the electrodeless lamp.

### DETAILED DESCRIPTION OF THE INVENTION

According to the present invention, techniques for lighting are provided. In particular, the present invention provides a method and device using an electrodeless plasma lighting device having a dielectric waveguide body having a width greater than a length, but can be other spatial configurations. Merely by way of example, the invention can be applied to a variety of applications such as stadiums, security, parking lots, military and defense, streets, large and small buildings, vehicle headlamps, aircraft landing, bridges, warehouses, uv water treatment, agriculture, architectural lighting, stage lighting, medical illumination, microscopes, projectors and displays, any combination of these, and the like.

The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the Claims herein is not intended to invoke the provisions of 35 U.S.C. 112, Paragraph 6.

Please note, if used, the labels left, right, front, back, top, bottom, forward, reverse, clockwise and counter clockwise have been used for convenience purposes only and are not intended to imply any particular fixed direction. Instead, they are used to reflect relative locations and/or directions between various portions of an object. Additionally, the terms “first” and “second” or other like descriptors do not necessarily imply an order, but should be interpreted using ordinary meaning.

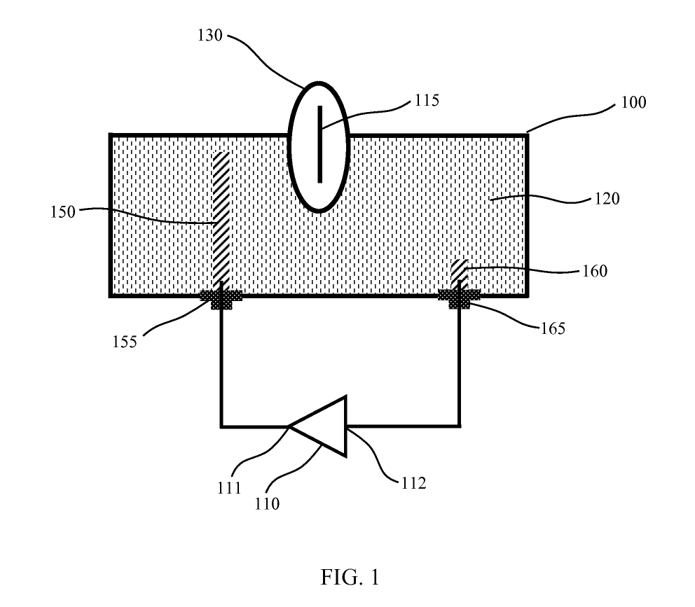

FIG. 1 is a simplified drawing of an embodiment of the present invention. This diagram is merely an example, which should not unduly limit the scope of the claims herein. One of ordinary skill in the art would recognize other variations, modifications, and alternatives. The resonator/waveguide 100 is made from a dielectric material 120 with a dielectric constant of less than 2. In a specific embodiment, the dielectric material comprises air, which has a dielectric constant of about 1. In various embodiments, resonator 100 comprises multiple dielectric materials, such as gas, fluid, and others. The surface of the dielectric material is covered with an electrically conductive layer or alternatively the resonator/waveguide can be made from a metallic housing and filled with the dielectric material. The gas filled vessel (bulb) 130 is inserted partially into the resonator/waveguide through a hole in the electrically conductive layer and the dielectric. The gas filled vessel is filled with an inert gas such as Argon or Xenon and a light emitter such as Mercury, Sodium, Dysprosium, Sulfur or a metal halide salt such as Indium Bromide, Scandium Bromide, Thallium Iodide, Holmium Bromide, Cesium Iodide or other similar materials (or it can simultaneously contain multiple light emitters). The RF coupling element 150 and feedback coupling element 160 are inserted into the resonator/waveguide through holes in the electrically conductive layer. The feedback coupling element is shorter than the RF coupling element. It is to be appreciated that the shorter length of the feedback coupling 160 compared to the RF coupling element 150 is specifically designed to provide appropriate resonant frequency.

An RF power amplifier 110 is connected between the feedback coupling element and the RF coupling element. The feedback coupling element 160 is connected to the input 112 of the RF power amplifier through an RF connector 165. The output of the RF amplifier 111 is connected to RF connector 155 which is connected to the RF coupling element 150. The resonator/waveguide in conjunction with the feedback coupling element, the amplifier, and the RF coupling element, form a resonant circuit and under the right oscillation condition the resonant circuit will oscillate and the RF amplifier will provide RF power to the resonator/waveguide. The resonator/waveguide couples the RF energy to the gas filled vessel resulting in ionization of the inert gas and vaporizing the light emitter(s) resulting in intense light emitted from the lamp 115.

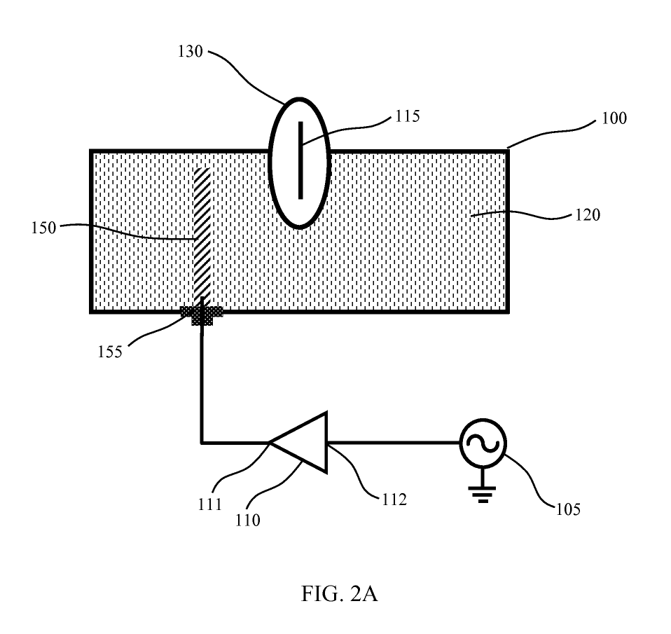

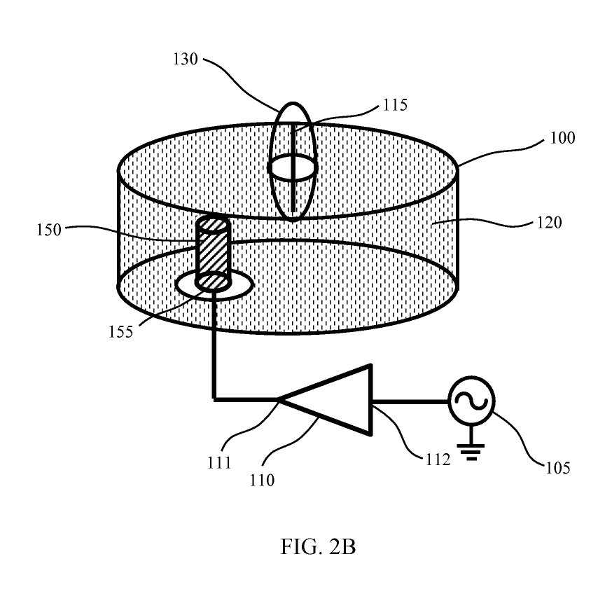

FIG. 2A is a simplified drawing of another embodiment of the present invention. This diagram is merely an example, which should not unduly limit the scope of the claims herein. One of ordinary skill in the art would recognize other variations, modifications, and alternatives. This embodiment is similar to FIG. 1 except that the resonator/waveguide does not have a feedback coupling element. Instead an RF source 105 in conjunction with an RF amplifier 110 is used to provide RF power to the resonator/waveguide and to the lamp.

FIG. 2B is a simplified perspective view of the lamp shown in FIG. 2A illustrating the electrodeless plasma lamp with RF coupling element and without a feedback coupling element. A cylindrical lamp body is depicted, but rectangular or other shapes may be used. This diagram is merely an example, which should not unduly limit the scope of the claims herein. One of ordinary skill in the art would recognize other variations, modifications, and alternatives.

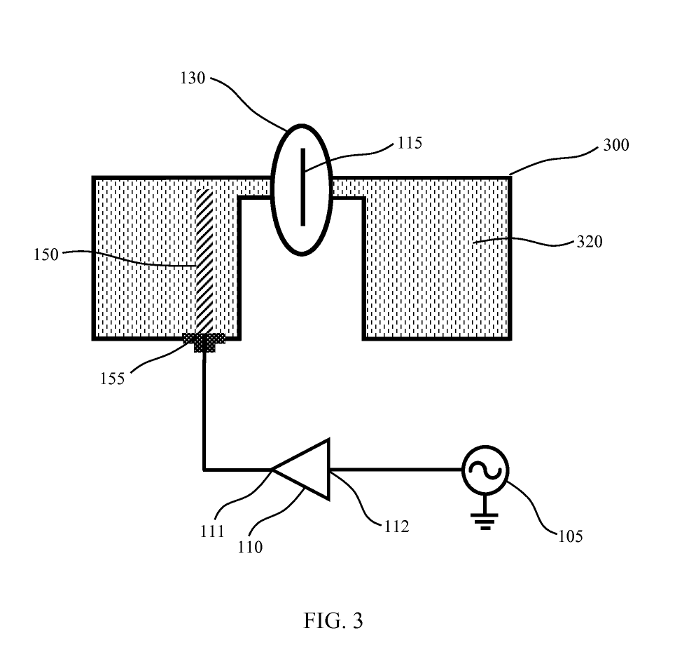

FIG. 3 is a simplified drawing of another embodiment of the present invention of an electrodeless plasma lamp. This diagram is merely an example, which should not unduly limit the scope of the claims herein. One of ordinary skill in the art would recognize other variations, modifications, and alternatives. This embodiment is similar to FIG. 2A but a folded resonator/waveguide structure 300 is used instead to achieve a more compact structure using dielectric materials 320 with a dielectric constant of less than 2.

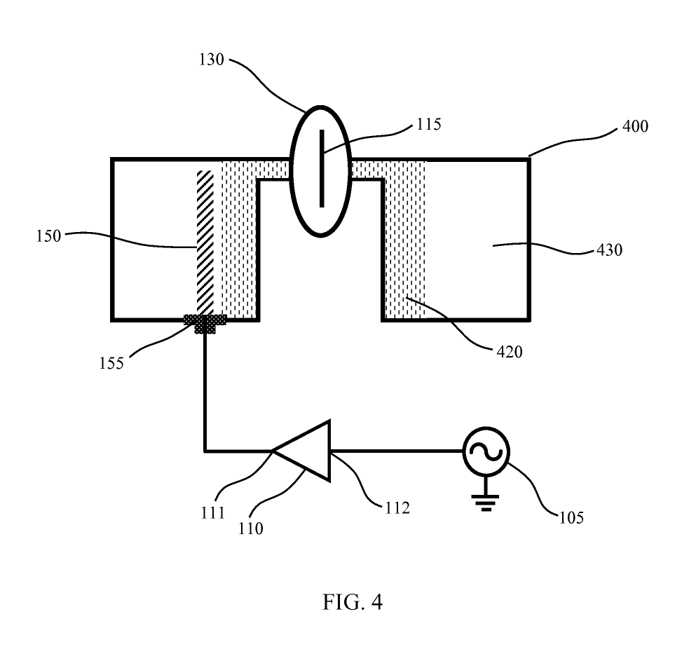

FIG. 4 is a simplified drawing of another embodiment of the present invention of an electrodeless plasma lamp. This diagram is merely an example, which should not unduly limit the scope of the claims herein. One of ordinary skill in the art would recognize other variations, modifications, and alternatives. This embodiment is similar to FIG. 3 but the resonator/waveguide 400 includes multiple dielectric materials 420 and 430 to improve the performance of the electrodeless lamp. Part of the resonator/waveguide can also be filled with air or vacuum to lower the overall RF loss of the resonator/waveguide and improve the performance of the lamp.

According to an embodiment, the present invention provides a plasma lamp. The plasma lamp includes a waveguide body that includes at least one solid dielectric material. The waveguide includes a body having a diameter and a length transverse to the diameter, wherein the diameter of the body is less than the length of the body. In one embodiment, the body further comprises at least a fluid material. In another embodiment, the body further comprises at least one conductive material. For example, the one solid conductive material is selected from a metal material. In a specific embodiment, the body further comprises at least a second solid dielectric material. As an example, the body further comprises at least a third solid dielectric material. Depending on the application, the body further may further comprise a dielectric material having a higher dielectric constant within a vicinity of the fill of the lamp relative to a portion of the dielectric material further away from the vicinity of the fill of the lamp.

In one embodiment, the body has an electrically conductive coating on an outer surface of the body except in a region where the power is provided from the body to the fill. For example, the outer surface has an electrically conductive coating and the opening exposes at least one uncoated surface of the body through which power is provided from the body to the fill. The body can be in a cylindrical prism shape.

In certain embodiments, the diameter of the body is less than about one wavelength of the power in the body at about the resonant frequency. In a specific embodiment, the diameter of the body is equal to about one half wavelength of the power in the body at about the resonant frequency. In yet another embodiment, the length of the body is less than about one half wavelength of the power in the body at about the resonant frequency.

In a specific embodiment, the body includes a dielectric constant greater than about 2. The diameter of the body is less than about one wavelength of the power in the body at the resonant frequency. The body has a dielectric constant greater than about 2. The body includes an outer surface coated with an electrically conductive material. The body has a central axis transverse to the diameter of the body and the bulb is positioned at about the central axis of the body proximate to an electric field maxima of the power in the body. The lamp further includes a probe inserted into the body aligned substantially parallel to the central axis of the body, the probe coupled to the source to provide the power from the source to the body. More specifically, the body is characterized by (1) a loss tangent less than approximately 0.01, (2) a DC breakdown threshold greater than approximately 200 kilovolts/inch, (3) a thermal shock resistance quantified by a failure temperature greater than approximately 200 degree C., and (4) a coefficient of thermal expansion less than approximately 10-5/degree C.

The plasma lamp further includes a power source configured to provide power to the body at about a frequency that resonates within the body. For example, the source is configured to excite a zeroth order Bessel mode in the body. In one embodiment, the plasma lamp further includes a first feed coupled to the source to provide the power from the source to the body and a second feed coupled to the body. For example, the power is provided at a frequency in the range of about 500 MHz to 10 GHz and resonates within the body in a fundamental resonant mode.

Depending on the application, the body consists essentially of the at least one solid dielectric material and has a volume greater than a volume of the bulb. In one embodiment, the body consists essentially of the at least one solid dielectric material and has a volume greater than a volume of the bulb. For example, the body consists essentially of the at least one solid dielectric material and has a volume greater than a volume of the bulb.

The waveguide body has an effective length comprising at least a portion of the diameter and one or more portions of the length to cause the frequency to resonate within the body. The length is selected to achieve a determined resonance frequency from a plurality of resonance frequencies. The plurality of resonance frequencies can be less than about 900 MHz. In a specific embodiment, the plurality of resonance frequencies is less than about 500 MHz. In another embodiment, the plurality of resonance frequencies is less than about 250 MHz. In yet another embodiment, the plurality of resonance frequencies is less than about 150 MHz.

The plasma lamp further includes a fill positioned proximate to the body to receive the power from the body. The fill of the plasma lamp is capable of forming a plasma when the power is received from the body. For example, the fill is provided in a bulb, and the bulb is configured as a cylinder, annular shaped, and egg. For example, the bulb encloses the fill. In an embodiment, the body forms an opening and at least a portion of the bulb is positioned in the opening. In a specific embodiment, at least a portion of the bulb extends from within the opening to an outer surface of the body such that light is transmitted through the bulb away from the body. For example, the bulb has a transparent portion positioned outside of the opening through which light is transmitted away from the body. In an embodiment, the bulb is positioned proximate to an electric field maxima of the power in the body. For example, the body has a central axis transverse to the diameter of the body and the bulb is positioned at about the central axis of the body.

In an embodiment, the plasma lamp also includes a probe inserted into the body in a direction substantially parallel to the central axis of the body. The probe is coupled to the source to provide the power from the source to the body. The source includes an amplifier. A feed is coupled to the body to provide feedback from the body to the amplifier.

According to another embodiment, the present invention provides a method for manufacturing an electrodeless plasma lamp. The method includes providing a plasma lamp including a waveguide body comprising at least one solid dielectric material, wherein the body has a diameter and a length transverse to the diameter and the diameter of the body is greater than the length of the body. The method also includes coupling power into the body at about a frequency that resonates within the body. The method further includes positioning a fill proximate to the body to receive the power from the body to form light emitting plasma. The method further comprises providing the power from the body to the fill to form a light emitting plasma. The method also includes adjusting the frequency of the power after the light emitting plasma is formed. The method also includes transmitting light from the plasma through an opening formed in a surface of the body. As an example, the surface is coated with an electrically conductive material.

In an embodiment, the method includes enclosing the fill in a bulb and substantially containing the power at the outer surface of the body except for at least one region proximate the bulb and at least one region where power is coupled between a source and the body. The method includes causing the power to resonate in the body at a fundamental resonant mode. The method also includes causing the power to resonate in the body in a resonant mode that is substantially independent of the length of the body.

According to yet another embodiment, the present invention provides a method for making an electrodeless plasma lamp. The method includes providing a plasma lamp. The plasma lamp includes a waveguide body comprising at least one dielectric material having a dielectric constant greater than 2, wherein the body has a diameter and a length transverse to the diameter and the diameter of the body is greater than the length of the body. The method includes coupling microwave power into the body at about a frequency that resonates within the body. The method further includes providing the microwave power from the body to the light emitting plasma.

In various embodiment, the method includes causing the power to resonate in the body in a fundamental resonant mode determined by the diameter of the body. For example, the fundamental resonant mode is independent of the length of the body.

While embodiments and advantages of this invention have been shown and described, it would be apparent to those skilled in the art that many more modifications are possible without departing from the inventive concepts herein. The invention, therefore, is not to be restricted except in the spirit of the appended claims.

What is claimed is:

1. A plasma lamp comprising:
a waveguide body including at least one solid dielectric material, the body having a diameter and a length transverse to the diameter, wherein the diameter of the body is less than the length of the body;
a power source configured to provide power to the body at about a frequency that resonates within the body, the waveguide body having an effective length comprising at least a portion of the diameter and at least a portion of the length to cause the frequency to resonate within the body; and
a fill positioned proximate to the body to receive the power from the body, the fill of the plasma lamp capable of forming a plasma when the power is received from the body.

2. The plasma lamp of claim 1 wherein the fill is provided in a bulb, the bulb being configured as a cylinder, annular shaped, and egg.

3. The plasma lamp of claim 1 wherein the length is selected to achieve a determined resonance frequency from a plurality of resonance frequencies.

4. The plasma lamp of claim 3 wherein the plurality of resonance frequencies is less than about 900 MHz.

5. The plasma lamp of claim 3 wherein the plurality of resonance frequencies is less than about 500 MHz.

6. The plasma lamp of claim 3 wherein the plurality of resonance frequencies is less than about 250 MHz.

7. The plasma lamp of claim 3 wherein the plurality of resonance frequencies is less than about 150 MHz.

8. The plasma lamp of claim 1, wherein the body further comprises at least a fluid material.

9. The plasma lamp of claim 1 wherein the body further comprises at least one conductive material.

10. The plasma lamp of claim 9 wherein the one solid conductive material is selected from a metal material.

11. The plasma lamp of claim 1 wherein the body further comprises at least a second solid dielectric material.

12. The plasma lamp of claim 11 wherein the body further comprises at least a third solid dielectric material.

13. The plasma lamp of claim 1 wherein the body further comprises a dielectric material having a higher dielectric constant within a vicinity of the fill of the lamp relative to a portion of the dielectric material further away from the vicinity of the fill of the lamp.

14. The lamp of claim 1, further comprising a bulb that encloses the fill.

15. The lamp of claim 14, wherein the body forms an opening and at least a portion of the bulb is positioned in the opening.

16. The lamp of claim 15, wherein at least a portion of the bulb extends from within the opening to an outer surface of the body such that light is transmitted through the bulb away from the body.

17. The lamp of claim 15, wherein the bulb has a transparent portion positioned outside of the opening through which light is transmitted away from the body.

18. The lamp of claim 1, wherein the body has an electrically conductive coating on an outer surface of the body except in a region where the power is provided from the body to the fill.

19. The lamp of claim 16, wherein the outer surface has an electrically conductive coating and the opening exposes at least one uncoated surface of the body through which power is provided from the body to the fill.

20. The lamp of claim 1, wherein the body has a cylindrical prism shape.

21. The lamp of claim 14, wherein the bulb is positioned proximate to an electric field maxima of the power in the body.

22. The lamp of claim 1, wherein the diameter of the body is less than about one wavelength of the power in the body at about the resonant frequency.

23. The lamp of claim 1, wherein the diameter of the body is equal to about one half wavelength of the power in the body at about the resonant frequency.

24. The lamp of claim 1, wherein the length of the body is less than about one half wavelength of the power in the body at about the resonant frequency.

25. The lamp of claim 1, wherein the source is configured to excite a zeroeth order Bessel mode in the body.

26. The lamp of claim 1, further comprising a first feed coupled to the source to provide the power from the source to the body.

27. The lamp of claim 26, further comprising a second feed coupled to the body.

28. The lamp of claim 1, wherein the power is provided at a frequency in the range of about 500 MHz to 10 GHz and resonates within the body in a fundamental resonant mode.

29. The lamp of claim 14, wherein the body has a central axis transverse to the diameter of the body and the bulb is positioned at about the central axis of the body.

30. The lamp of claim 29, further comprising a probe inserted into the body in a direction substantially parallel to the central axis of the body, the probe coupled to the source to provide the power from the source to the body.

31. The lamp of claim 1, wherein the source includes an amplifier, the lamp further comprising a feed coupled to the body to provide feedback from the body to the amplifier.

32. The lamp of claim 1, wherein the body comprises a dielectric constant greater than about 2.

33. The lamp of claim 28, wherein the diameter of the body is less than about one wavelength of the power in the body at the resonant frequency, the body has a dielectric constant greater than about 2, and the body includes an outer surface coated with an electrically conductive material.

34. The lamp of claim 33, wherein the body has a central axis transverse to the diameter of the body and the bulb is positioned at about the central axis of the body proximate to an electric field maxima of the power in the body, the lamp further comprising a probe inserted into the body aligned substantially parallel to the central axis of the body, the probe coupled to the source to provide the power from the source to the body.

35. The lamp of claim 34, wherein the body comprises: a loss tangent less than approximately 0.01; a DC breakdown threshold greater than approximately 200 kilovolts/inch; a thermal shock resistance quantified by a failure temperature greater than approximately 200 degree C.; and a coefficient of thermal expansion less than approximately 10-5/degree C.

36. A method comprising:
providing a plasma lamp including a waveguide body comprising at least one solid dielectric material, wherein the body has a diameter and a length transverse to the diameter and the diameter of the body is greater than the length of the body;
coupling power into the body at about a frequency that resonates within the body; and
positioning a fill proximate to the body to receive the power from the body to form a light emitting plasma.

37. The method of claim 36, further comprising providing the power from the body to the fill to form a light emitting plasma.

38. The method of claim 36, further comprising adjusting the frequency of the power after the light emitting plasma is formed.

39. The method of claim 37, further comprising transmitting light from the plasma through an opening formed in a surface of the body.

40. The method of claim 39, wherein the surface is coated with an electrically conductive material.

41. The method of claim 36, further comprising enclosing the fill in a bulb and substantially containing the power at the outer surface of the body except for at least one region proximate the bulb and at least one region where power is coupled between a source and the body.

42. The method of claim 36, further comprising causing the power to resonate in the body at a fundamental resonant mode.

43. The method of claim 36, further comprising causing the power to resonate in the body in a resonant mode that is substantially independent of the length of the body.

44. A method comprising: providing a plasma lamp including a waveguide body comprising at least one dielectric material having a dielectric constant greater than 2, wherein the body has a diameter and a length transverse to the diameter and the diameter of the body is greater than the length of the body; coupling microwave power into the body at about a frequency that resonates within the body; and providing the microwave power from the body to the light emitting plasma.

45. The method of claim 44, further comprising causing the power to resonate in the body in a fundamental resonant mode determined by the diameter of the body.

46. The method of 45, wherein the fundamental resonant mode is independent of the length of the body.

47. The lamp of claim 1, wherein the body consists essentially of the at least one solid dielectric material and has a volume greater than a volume of the bulb.

48. The lamp of claim 18, wherein the body consists essentially of the at least one solid dielectric material and has a volume greater than a volume of the bulb.

49. The lamp of claim 24, wherein the body consists essentially of the at least one solid dielectric material and has a volume greater than a volume of the bulb.
